(19) United States
(12) Patent Application Publication
(10) Pub. No.: US 2023/0219391 A1
(43) Pub. Date: Jul. 13, 2023

(54) Driving Dynamics Control of a Vehicle by Means of Dampers

(71) Applicant: Volkswagen Aktiengesellschaft, Wolfsburg (DE)

(72) Inventor: Nando Laumanns, Wolfsburg (DE)

(73) Assignee: Volkswagen Aktiengesellschaft, Wolfsburg (DE)

(21) Appl. No.: 17/923,042

(22) PCT Filed: Apr. 21, 2021
(86) PCT No.: PCT/EP2021/060362

§ 371 Date: Nov. 3, 2022

(30) Foreign Application Priority Data
May 6, 2020 (DE) 10 2020 205 702.8

(51) Int. Cl. B60G 17/06; B60G 17/016; B60G 17/019

(52) U.S. Cl. CPC B60G 17/06; B60G 17/0164; B60G 17/01908; B60G 2400/204; B60G 2400/104; B60G 2500/10; B60G 2600/09

(57) ABSTRACT

The invention relates to a method for controlling the driving dynamics of a vehicle by means of dampers, wherein the vehicle comprises at least two axles, which each have at least two wheels including dampers, and wherein the method has the following control:

a) Obtaining a target driving dynamics variable;

b) determining a control deviation using the target driving dynamics variable and an actual driving dynamics variable;

c) Changing the damper force of at least one damper according to the control deviation;

d) Updating and feeding back the actual driving dynamics variable to once again determine the control deviation when the damper force changes.

### CROSS-REFERENCE TO RELATED APPLICATIONS

This application claims priority to German Patent Application No. DE 10 2020 205 702.8, filed on May 6, 2020 with the German Patent and Trademark Office. The contents of the aforesaid Patent Application are incorporated herein for all purposes.

### TECHNICAL FIELD

The invention relates to a method for controlling the driving dynamics of a vehicle, in particular of a motor vehicle, such as, for example, a passenger car or a truck. The driving dynamics are controlled here by means of dampers on the vehicle wheels. In particular, the lateral dynamics and further particularly the yawing behavior of the vehicle and in particular a rolling-yawing moment can be controlled. The invention also relates to a vehicle and a control apparatus which have or, respectively, provide such a driving dynamics control.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The wheels of a vehicle may be connected by means of dampers, via which the wheels can be supported on a vehicle body. The dampers generate damping forces, which influence the forces acting between the vehicle wheels and the road.

Controlled or adaptive dampers may be provided, in which the generated damping forces can be variably set during driving operation. For example, a driver can select a damping behavior from a plurality of selection possibilities, for example a sporty or comfortable damping behavior. Depending on the driving situation, the damping forces to be generated are ascertained and set by a control depending on this selection. This control, however, is limited to the correct application of the specified damping forces by the individual dampers. For example, this control ensures that a specified change in current or another operating variable of the dampers that must be adjusted to generate the desired damping forces is actually applied. The damping force to be set is typically ascertained using characteristic curves, which can obtain vehicle dynamics variables from body sensors of the vehicle as input variables.

However, it has been shown that, as before, there is still potential for improvement, for example in the case of influences of driving dynamics and in particular of lateral dynamics. This applies in particular in driving dynamics limit ranges.

### SUMMARY

A need exists for a solution to improve the reliability and effectiveness of influencing driving dynamics by means of dampers of a vehicle.

The need is addressed by the subject matter of the independent claims. Some embodiments are described in the dependent claims, the following description, and the drawings. Unless otherwise specified or apparent, all of the explanations, features and embodiments in the preceding may apply to or, respectively, be provided in embodiments.

### BRIEF DESCRIPTION OF THE DRAWINGS

FIG. 1 shows a driving dynamics control of a vehicle according to one exemplary embodiment in a schematic representation;

FIG. 2 shows a flow chart of a method according to one exemplary embodiment, which is executed by the vehicle or, respectively, its driving dynamics control from FIG. 1.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

It has been recognized that, in particular in driving dynamics limit ranges, the influences of the dampers on the driving dynamics may only be modeled or, respectively, predicted to a limited degree. Accordingly, the driving dynamics cannot always be reliably influenced in the desired manner with the previous approaches. The solutions disclosed here therefore provide that a dynamics variable to be influenced is controlled and the damper is used as an actuator for this.

This differs from the previous approaches, in which the dynamics variable is used, for example using a characteristic curve, only to ascertain a damper force (also described herein with the same meaning as damping force) to be set by the damper. In this case, a fixed or, respectively, universally valid relationship between the damper force and the dynamics variable is usually assumed. As a result, it is considered sufficient that damper forces to be set are specified by a control without separately detecting and taking into account their actual effects on the driving dynamics. In the present case, it has been recognized that such a fixed relationship between the damper force and driving dynamics, in particular in the driving dynamics limit ranges, may not always apply and in general are difficult to model.

The solutions disclosed herein enable checking or, respectively, ensuring through a control that a target dynamics variable specified as a guidance variable by the adaptive dampers of the vehicle is actually applied. For this purpose, an actual dynamics variable can be ascertained which occurs as a result of the adaptive damping forces. The actual dynamics variable can be subtracted from the target dynamics variable to ascertain a control deviation. This control deviation can be used to ascertain and/or to update a manipulated variable to be applied by the damper. This corresponds to the formation of a control loop with the goal of adjusting the actual dynamics variable to the target dynamics variable by using the dampers as an actuator.

Expressed in general terms, the solutions disclosed herein provide that a deviation between a target and an actual driving state (in particular a target and actual dynamics variable) is ascertained and the dampers of a vehicle are set depending on this deviation such that this deviation is reduced. This can improve the driving stability, in particular when the target dynamics variable enables the provision of a correspondingly increased stability or, respectively, has been ascertained for this purpose.

In particular, a method for controlling the driving dynamics (in particular lateral dynamics control and further particularly the yawing behavior) of a vehicle by means of (in particular adaptive, controlled and/or actuatable) dampers is proposed (which are controlled, for example, to generate rolling-yawing moments),

wherein the vehicle comprises a plurality of wheels (in particular at least four), which are each connected to a damper (and are thereby supported by it, for example, on the vehicle body). More precisely, the vehicle comprises at least two axles (in particular a front axle and a rear axle), which each have at least two wheels and (connected to them) dampers (for example one per wheel). The method here has the following control or, in other words, forms the following control loop:
a) Obtaining a target driving dynamics variable;
b) Ascertaining a control deviation using or based on the target driving dynamics variable and an actual driving dynamics variable;
c) Changing the damper force (or also damping force) of at least one damper according to the control deviation;
d) (In particular updating and) feeding back the actual driving dynamics variable to once again ascertain the control deviation when the damper force changes.

Due to the changed damper force, the fed-back actual driving dynamics variable has a changed value as expected, i.e., as expected does not correspond with that actual variable on the basis of which the control deviation was previously determined.

Once again ascertaining the control deviation can comprise or involve also once again executing measure a), but at least the measures b) and c). This can be repeated until the control deviation becomes zero or, for example, until the driving dynamics control is deactivated. In particular, it can be provided that the driving dynamics control is activated over a longer period of time and thereby continuously and/or repeatedly executes the sequence described in the preceding. In particular, the target driving dynamics variable can also be updated repeatedly and calculated against the fed-back actual driving dynamics variable to determine the control deviation.

Obtaining the target driving dynamics variable can also comprise ascertaining this variable. However, it can also be ascertained separately (for example, by a separate unit and/or generally outside of the claimed method) and the variable can be transmitted or output as an end result of this ascertainment and obtained in this way. To ascertain the target driving dynamics variable, characteristic diagrams or vehicle models can be used, as mentioned, for example, in DE 10 2018 203 182 A1, incorporated herein by reference (see [0021] therein, with the additional use of a steering angle as an input variable).

It is understood that the target driving dynamics variable and actual driving dynamics variable for example refer to a driving dynamics variable of the same type. In general, this driving dynamics variable may be a lateral dynamics variable. According to one example, the driving dynamics variable is the body slip angle. According to another example, it is the yaw rate. Alternatively, temporal derivations of any of the exemplary driving dynamics variables named herein could also be considered.

The relationship between the driving dynamics variables or, respectively, a present control deviation and a damper force to be set can be defined using any known approaches from the prior art. For example, characteristic curves or computing models may be saved for this purpose. The described relationships are described in DE 10 2018 203 182 A1, according to which lateral wheel forces may be set by the damper forces and then, for example, the yawing behavior or, respectively, the yaw rate may be influenced by this as a dynamics variable of the vehicle.

In the following, relationships between the damper forces and an oversteer or understeer are also described as additional examples, wherein the oversteer or understeer also correspond to a driving dynamics variable or, respectively, can be ascertained using driving dynamics variables.

The dampers may have their own controls or, respectively, control loops to change the damper force, as explained in the preceding. In particular, a damper force may be obtained and/or specified as a target variable to be set. Then, it can be ensured, so to speak, by internal damper control and/or, for example, by adjusting electrical operating variables that this damper force is actually applied. A control speed or, respectively, frequency of the dampers can be higher here than a control speed of the driving dynamics or, respectively, of the superordinate control loop described in the preceding.

In summary, a control of the damper force by the dampers may thus be embedded in the superordinate driving dynamics control in the manner of a cascade control. This increases the reliability and the quality when applying the desired driving dynamics adjustment.

In general, a method according to any of the aspects described herein can be executed in a computer-assisted manner. In particular, it can be executed by means of a control apparatus or control circuit (in particular provided by a control device with a control function) as explained in the following. The control functions or, respectively, control loops described herein can be applied by algorithms and/or program commands or, respectively, be defined as such. These can be executed by the control apparatus (in particular a processor of it).

Some embodiments provide that the actual driving dynamics variable is measured with a sensor and/or is ascertained based on a model. For example, a yaw rate can be determined as the driving dynamics variable by means of a yaw rate sensor. In contrast, a body slip angle as the driving dynamics variable is for example ascertained based on a model and thus by a computer.

Some embodiments provide that, to change the damper force, a target variable relating to the damper force is output to a damper control device (for the at least one damper, the control force of which is to be changed). The damper control device for example provides a control function and in particular a damper controller. This enables in particular the version described in the preceding of an inner damper control loop in the manner of a cascade control. The damper controller may be, for example, a software executed by the damper control device or a software function for actuating a damper.

In particular, the target variable may be a target damper force which the damper control device uses, for example, using characteristic curves, a computing model or other known approaches, to ascertain a necessary current change or other operating variable change for actuating the damper, so that the target damper force is applied. An actual damper force or an actual operating variable can be fed back to the control.

It can also be provided that the damper force can be changed individually for each wheel. For this purpose, any control or, respectively, control loop described herein can be performed individually for each wheel. In particular, target driving dynamics variables to be set individually for each wheel can be ascertained. Alternatively, it can be provided, for example considering a control deviation, to ascertain damper forces to be set individually for each wheel to reduce this control deviation.

Formulated generally, the manipulated variable determination can thus take place individually for each wheel, but not necessarily the ascertainment of the control deviation and/or of the target dynamics variable. The latter may be defined and/or specified, for example, in relation to the entire vehicle. For the conversion or also translation of the control deviation into manipulated variables that are individual to each wheel, computing models can be used, as described, for example, in DE 10 2018 203 182 A1 in conjunction with lateral forces individual to each wheel and their influence on superordinate lateral dynamics of the vehicle.

A benefit of individual settings for each wheel is a higher precision in influencing the driving dynamics.

Alternatively, it can be provided, that the damper force is changed for each axle individually. This can be understood to mean that, for all dampers of an axle, similar (for example, as a percentage or relative) changes or similar (for example, absolute) settings of the damper force are ascertained and then correspondingly applied. However, these damper forces or, respectively, changes or settings can differ from those on another axle.

A benefit of individual settings for each axle is a higher control speed when influencing the driving dynamics, since the computing effort can be lower compared to the version done individually for each wheel.

The driving dynamics variable may describe understeer or oversteer of the vehicle. In other words, understeer or oversteer of the vehicle may be ascertainable using the driving dynamics variable. For example, the driving dynamics variable can be a yaw rate. The control deviation can accordingly correspond to a yaw rate deviation between the target and actual yaw rates. If this deviation is positive, oversteer may be present. If it is negative, understeer may be present.

Some embodiments provide that, in the case of understeer (meaning, for example, when the driving dynamics variable is a yaw rate and/or a yaw rate deviation of the preceding type is negative), the damper forces on a front axle are increased and/or the damper forces on a rear axle are reduced. This adjustment of the damper forces can take place again via individual settings for each axle. However, it can also take place via individual settings for each wheel, in which the damper forces at the wheels of the axles are set individually, but on the front axle each is individually increased and/or on the rear axle each is individually reduced.

It has been shown that, with a corresponding adjustment of the damper forces, understeer can be reliably limited particularly in the driving dynamics limit range.

Additionally or alternatively, it can be provided that, in the case of oversteer (meaning, for example, when the driving dynamics variable is a yaw rate and/or a yaw rate deviation of the preceding type is positive), the damper forces on the front axle are reduced and/or the damper forces on the rear axle are increased. This adjustment of the damper forces can take place again via individual settings for each axle. However, it may also take place via a setting individually for each wheel, in which the damper forces at the wheels of the axles are set individually, but on the front axle each is individually reduced and/or on the rear axle each is individually increased.

It has been shown that, with a corresponding adjustment of the damper forces, oversteer can be reliably limited particularly in the driving dynamics limit range.

In some embodiments, the change of the damper force is ascertained depending on the driving speed and/or the lateral acceleration. In particular, the damper force can be determined by means of a characteristic curve or a characteristic diagram which are defined depending on at least one of the named variables. For example, depending on the present control deviation, depending on the current driving speed and/or depending on the lateral acceleration ascertained by sensors or based on models, the damper force to be set as a result can be ascertained. Again, this can take place individually for each wheel or individually for each axle.

This disclosure also relates to a vehicle (in particular a motor vehicle and for example a passenger car or a truck), with at least two axles (for example, a front and a rear axle), which each have at least two wheels including dampers (more precisely, each with one damper), and with a control apparatus which is configured to:
ascertain a target driving dynamics variable;
ascertain a control deviation using the target driving dynamics variable and an actual driving dynamics variable;
based on this, ascertain and/or output a specification relating to a change of the damper force of at least one damper (e.g., in the form of a new target value or a change specification for the damper force); and
once again ascertain (and in doing so, in other words, to update) the control deviation (for example, that is to be set as a result and/or which results) on the basis of the actual driving dynamics variable when the damper force changes.

The control apparatus can be provided by a control apparatus (control circuit) of the vehicle with a corresponding control function. The control apparatus can comprise at least one processor and/or at least one storage (apparatus). Program commands can be saved in the storage, which, when these commands are executed by the processor, cause the control apparatus to provide any functions, operating states or measures described herein.

In general, the vehicle and in particular its control apparatus can comprise any additional features in order to provide all the operating states, functions and effects described herein. In particular, all explanations and developments of method features can also apply to the identical or similar features of the vehicle and in particular its control apparatus or, respectively, can be provided in it. In general, the vehicle and in particular its control apparatus can be configured to execute a method according to any aspect described herein.

The present disclosure also relates to a control apparatus (control circuit) for a vehicle according to the preceding.

Further exemplary embodiments of the invention are discussed below using the appended schematic FIGS.

Specific references to components, process steps, and other elements are not intended to be limiting. Further, it is understood that like parts bear the same or similar reference numerals when referring to alternate FIGS.

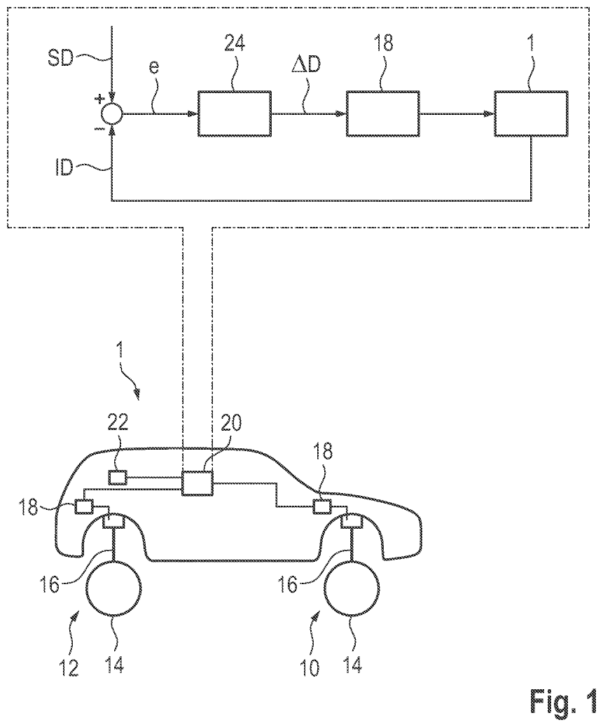

FIG. 1 shows an exemplary vehicle 1 in a greatly simplified side view. The vehicle 1 comprises a front axle 10 and a rear axle 12. Two vehicle wheels 14 are arranged on each of these, of which one per axle 10, 12 is covered in the view shown.

The vehicle wheels 14 are each connected to adaptive dampers 16 of a conventional design. More precisely, they are connected to the vehicle body via the dampers 16 and are supported on the vehicle body by the dampers 16. It is not shown that the dampers 16 are embedded into a spring damper system.

Each damper 16 has a damper control device (control circuit) 18. The damper control device 18 provides a control function or, respectively, forms a damper controller. It is configured to set and for example adjust an obtained target damper force for an associated damper 16 by adjusting electrical variables of this damper 16 and in particular through current changes.

A control apparatus 20 of the vehicle 1 is also shown. This can be provided by a digital and/or electrically operable control device or be implemented as such. The control apparatus 20 is connected to the damper control devices 18 of each damper 16 via data lines and for example via a communication bus, which is not shown separately.

A schematic control circuit or, respectively, a control loop which can be implemented by the control apparatus 20 is shown enlarged. Accordingly, the control apparatus 20 obtains (or for example ascertains) a target dynamics variable SD. Merely by way of example, it is presently a yaw rate of the vehicle 1, which can be ascertained, for example, by means of conventional model-based approaches.

Furthermore, the control apparatus 20 also obtains or for example ascertains an actual dynamics variable ID, wherein in the case shown it is once again the yaw rate of the vehicle 1. This can be ascertained with a sensor by means of a yaw rate sensor 22 that is connected to the control apparatus 20.

By calculating the difference between the target dynamics variable SD and the actual dynamics variable ID, a control deviation e is determined. Since the driving dynamics variable considered by way of example is the yaw rate, the control deviation e corresponds to a yaw rate deviation. In the manner described in the preceding, this models, with its sign, understeer or oversteer, which is reduced by the control apparatus 20 in the course of the driving dynamics control.

The control deviation e is supplied to a manipulated variable ascertaining function 24. The manipulated variable ascertaining function 24 models relationships between the manipulated variable (in the present case a damper force) and the control deviation e, in particular in the manner that changes or values of the manipulated variable can be ascertained in order to reduce the control deviation e. Once again, such relationships can be defined based on models or ascertained. A relationship between a yaw rate and the damper forces exists in the manner described in the preceding, for example, due to the lateral wheel forces that can be generated according to the damper forces and that influence the yawing behavior in particular when the vehicle 1 rolls.

In the example shown, the manipulated variable is determined individually for each axle. More precisely, for each axle 10, 12, the relative change of the damper force D to be made in each case by the dampers 16 there, or a new target value of the damper force D, is determined in order to reduce the control deviation e. This relative change and the target value are each examples of specifications generated by the control apparatus 20 relating to a desired or, respectively, necessary change of the damper force D.

When determining the manipulated variable, it is first established whether the control deviation e currently indicates oversteer or understeer, which in the manner described in the preceding can take place by checking its sign. Then, any of the changes of the damper force D made individually at each axle can be specified to reduce the oversteer or understeer, as has been explained in the preceding in the general description part.

It is not shown separately that the vehicle speed or lateral acceleration can also be taken into account when determining the manipulated variable. The control apparatus 20 can obtain these variables from sensors present in the vehicle 1.

As indicated schematically, the change of the damper force D to be made (alternatively an absolute target value of the damper force D) is output to the damper control devices 18. Merely for reasons of illustration, only one damper force D and one damper control device 18 are shown within the control diagram. As a result of the individual changes at each axle, the damper control devices 18 of the dampers 16 of a common axle 10, 12 obtain the same specifications from the manipulated variable ascertaining function 24.

The damper control devices 18 may for example adjust the damper force D or, respectively, its change, for example, by adjusting and in particular controlling the respective damper currents in the context of its own control loop described in the preceding. This affects the driving dynamics behavior of the controlled system, which is the vehicle 1 in the present case. The driving dynamics behavior is in this case detected via the described actual dynamics variable ID. The latter is continuously updated in the manner of a conventional control and thus also after setting the changed damper force D by means of the damper control devices 18. In this manner, the effects of the changes to the damper forces D on the control deviation e can be ascertained continuously and the control deviation e can be reduced by continuously adjusting and readjusting the damper forces D.

Overall, the driving dynamics of the vehicle 1 and, in the example shown, its yawing behavior are thus controlled, wherein the dampers 18 are used as actuators and the damper forces D or, respectively, their change generated by the dampers are used as a manipulated variable. Deviating from the prior art, it is checked and ensured by means of the control that the adjustments of the damping behavior actually result in the desired influence of the driving dynamics.

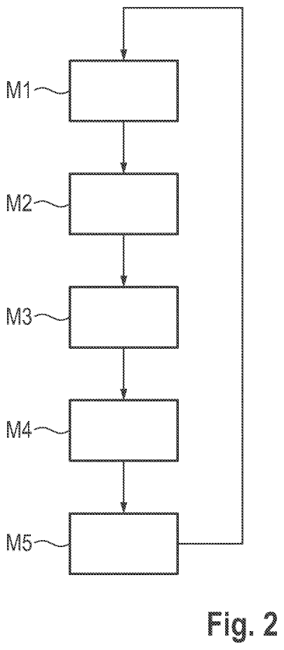

FIG. 2 shows a flow chart of a method as it is applied by the vehicle 1 in the manner described. As part of a measure M1, the target dynamics variable SD is obtained and/or ascertained. As part of a measure M2, the control deviation e is determined using the target dynamics variable SD and an actual dynamics variable ID for example measured with a sensor.

As part of a measure M3, changes of the damper forces D are ascertained as manipulated variables in order to reduce the control deviation e. As part of a measure M4, these damper forces D are each adjusted by the damper control devices 18. As a measure M5, an actual dynamics variable ID set as a result is ascertained or, respectively, a current value of the actual dynamics variable ID is ascertained. Furthermore, the actual dynamics variable ID is fed back in order to be taken into account when the measures M1-M5 are run through again, as part of measure M2, as a new or, respectively, current actual dynamics variable ID for ascertaining the control deviation e. The measure M1 is for example only repeated when the target dynamics variable SD has changed. In general, this control loop can be repeated until a driving dynamics control is deactivated.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

### LIST OF REFERENCE NUMERALS

1 Vehicle

10 Front axle

12 Rear axle

14 Vehicle wheel

16 Damper

18 Damper control device

20 Control apparatus

22 Yaw rate sensor

24 Manipulated variable ascertaining function

SD Target dynamics variable

ID Actual dynamics variable

e Control deviation

What is claimed is:

1. A method for controlling the driving dynamics of a vehicle using dampers,
wherein the vehicle comprises at least two axles, which each have at least two wheels, each wheel with one damper, the method comprising the following control:
obtaining a target driving dynamics variable;
determining a control deviation using the target driving dynamics variable and an actual driving dynamics variable;
changing the damper force of at least one damper according to the control deviation; and
updating and feeding back the actual driving dynamics variable when the damper force changes to again determine the control deviation.

2. The method of claim 1, comprising measuring the actual driving dynamics variable with a sensor and/or ascertaining the actual driving dynamics based on a model.

3. The method of claim 1, wherein, to change the damper force, a target variable relating to the damper force is output to a damper control device.

4. The method of claim 1, wherein the damper force is changed individually for each wheel.

5. The method of claim 1, wherein the damper force is changed individually for each axle.

6. The method of claim 1, comprising, in the case of understeer, increasing the damper forces on a front axle and/or decreasing the damper forces on a rear axle.

7. The method of claim 1, comprising, in the case of oversteer, reducing the damper forces on a front axle and/or increasing the damper forces on a rear axle.

8. The method of claim 1,
wherein the change of the damper force is dependent on a driving speed and/or of a lateral acceleration.

9. A vehicle, with at least two axles, which axles each have at least two wheels, each wheel with one damper, and with a control apparatus which is configured to:
determine a target driving dynamics variable;
determine a control deviation using the target driving dynamics variable and an actual driving dynamics variable;
based on this, determine a specification relating to a change of the damper force of at least one damper; and
again determine the control deviation on the basis of the actual driving dynamics variable when the damper force changes.

10. A control device for a vehicle with at least two axles, which axles each have at least two wheels, each wheel with one damper, the control device being configured to:
determine a target driving dynamics variable;
determine a control deviation using the target driving dynamics variable and an actual driving dynamics variable;
based on this, determine a specification relating to a change of the damper force of at least one damper; and
again determine the control on the basis of the actual driving dynamics variable when the damper force changes.

11. The method of claim 2, wherein, to change the damper force, a target variable relating to the damper force is output to a damper control device.

12. The method of claim 2, wherein the damper force is changed individually for each wheel.

13. The method of claim 3, wherein the damper force is changed individually for each wheel.

14. The method of claim 2, wherein the damper force is changed individually for each axle.

15. The method of claim 3, wherein the damper force is changed individually for each axle.

16. The method of claim 4, wherein the damper force is changed individually for each axle.

17. The method of claim 2, comprising, in the case of understeer, increasing the damper forces on a front axle and/or decreasing the damper forces on a rear axle.

18. The method of claim 3, comprising, in the case of understeer, increasing the damper forces on a front axle and/or decreasing the damper forces on a rear axle.

19. The method of claim 4, comprising, in the case of understeer, increasing the damper forces on a front axle and/or decreasing the damper forces on a rear axle.

20. The method of claim 5, comprising, in the case of understeer, increasing the damper forces on a front axle and/or decreasing the damper forces on a rear axle.
